(19) United States
(12) Patent Application Publication
(10) Pub. No.: US 2023/0294663 A1
(43) Pub. Date: Sep. 21, 2023

(54) HYBRID ELECTRIC VEHICLE

(71) Applicant: TOYOTA JIDOSHA KABUSHIKI KAISHA, Aichi-ken (JP)

(72) Inventors: Takehiro KOMATSU, Toyota-shi (JP); Masahiro NOGUCHI, Handa-shi (JP); Tomohiro NAKANO, Nagoya-shi (JP)

(21) Appl. No.: 17/978,215

(22) Filed: Nov. 1, 2022

(30) Foreign Application Priority Data
Jan. 21, 2022 (JP) 2022-007890

(51) Int. Cl. B60W 20/15; B60K 6/48; B60W 10/06; B60W 10/08; B60W 10/02

(52) U.S. Cl. CPC B60W 20/15; B60K 6/48; B60W 10/024; B60W 10/06; B60W 10/08; B60W 2510/242; B60W 2710/02

(57) ABSTRACT

A hybrid electric vehicle includes an engine including a cylinder and a spark plug, a motor, a clutch provided between the engine and the motor, and a control device configured to start combustion in the engine by supplying electric power to the spark plug while cranking the engine via the clutch using the motor when a start request for the engine is issued. The control device includes a measuring unit configured to measure a power supply time of the spark plug in cranking of the engine, a count unit configured to count a long-time power supply number which is the number of times the power supply time is equal to or greater than a predetermined first time, and a correction unit configured to correct a cranking torque necessary for cranking the engine and required for the motor such that the cranking torque increases as the long-time power supply number increases.

### CROSS-REFERENCE TO RELATED APPLICATION

This application claims priority to Japanese Patent Application No. 2022-007890 filed on Jan. 21, 2022, incorporated herein by reference in its entirety.

### BACKGROUND

### 1. Technical Field

The disclosure relates to a hybrid electric vehicle.

### 2. Description of Related Art

A hybrid electric vehicle that includes an engine and a motor which are power sources for traveling and starts the engine by cranking the engine using the motor is known (for example, see Japanese Unexamined Patent Application Publication No. 2016-175544 (JP 2016-175544 A)).

### SUMMARY

When a cranking torque is insufficient and thus an engine rotation speed in cranking decreases, a power supply time of a spark plug is correlated with a predetermined crank angle section and thus the power supply time of the spark plug is extended. When supply of electric power to the spark plug over a long time is repeated, there is concern about deterioration in durability of the spark plug.

Therefore, the disclosure provides a hybrid electric vehicle with secured durability of a spark plug.

According to an aspect of the disclosure, there is provided a hybrid electric vehicle including: an engine that is a power source for traveling including a cylinder and a spark plug provided in the cylinder; a motor that is a power source for traveling; a clutch that is provided between the engine and the motor; and a control device configured to start combustion in the engine by supplying electric power to the spark plug while cranking the engine via the clutch using the motor when a start request for the engine is issued, wherein the control device includes: a measuring unit configured to measure a power supply time of the spark plug in cranking of the engine; a count unit configured to count a long-time power supply number which is the number of times the power supply time is equal to or greater than a predetermined first time; and a correction unit configured to correct a cranking torque necessary for cranking the engine and required for the motor such that the cranking torque increases as the long-time power supply number increases.

The count unit may be configured to count a short-time power supply number which is the number of times the power supply time is equal to or less than a second time shorter than the first time and to decrease the long-time power supply number when the short-time power supply number is equal to or greater than a predetermined number.

The count unit may be configured to reset the short-time power supply number whenever the counted long-time power supply number reaches a predetermined number.

The engine may include a plurality of cylinders and a plurality of spark plugs that is provided in the plurality of cylinders, respectively. The measuring unit may be configured to measure the power supply time for each of the plurality of spark plugs, the count unit may be configured to count the long-time power supply number for each of the plurality of spark plugs, and the correction unit may be configured to correct the cranking torque based on a maximum value out of the long-time power supply numbers of the plurality of spark plugs.

The engine may include a plurality of cylinders and a plurality of spark plugs that is provided in the plurality of cylinders, respectively. The measuring unit may be configured to measure the power supply time for each of the plurality of spark plugs, the count unit may be configured to count the long-time power supply number for each of the plurality of spark plugs, and the correction unit may be configured to correct the cranking torque based on the long-time power supply number of the spark plug of the cylinder in which combustion is to start initially in cranking the engine.

According to the disclosure, it is possible to provide a hybrid electric vehicle with secured durability of a spark plug.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a hybrid electric vehicle;

FIG. 2 is a diagram schematically illustrating a configuration of an engine;

FIG. 3 is a flowchart illustrating an example of control for calculating count values LC and SC;

FIG. 4 is a flowchart illustrating an example of cranking torque correction control;

FIG. 5 is a diagram illustrating a map in which a relationship between the count value LC and an increase correction value of a cranking torque is defined; and

FIG. 6 is a flowchart illustrating a modified example of cranking torque correction control.

### DETAILED DESCRIPTION OF EMBODIMENTS

### Schematic Configuration of Hybrid Electric Vehicle

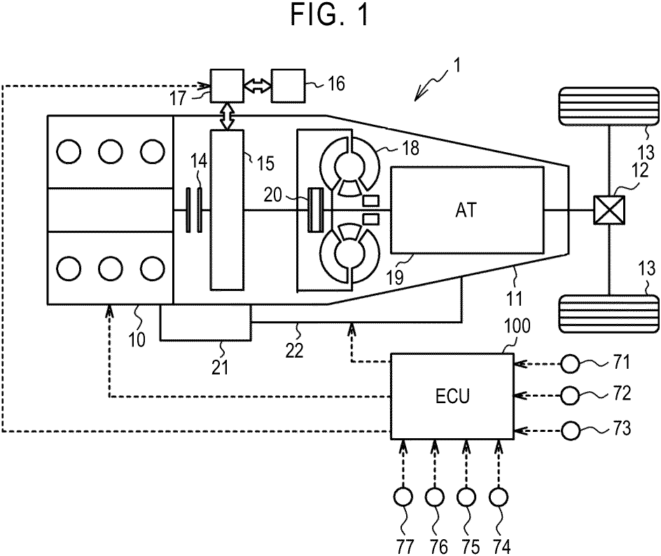

FIG. 1 is a diagram schematically illustrating a hybrid electric vehicle 1. In the hybrid electric vehicle 1, a K0 clutch 14, a motor 15, a torque converter 18, and a transmission 19 are sequentially provided in a power transmission path from an engine 10 to driving wheels 13. The engine 10 and the motor 15 are mounted as power sources for traveling of the hybrid electric vehicle 1. The engine 10 is, for example, a V-shaped 6-cylinder gasoline engine, but the number of cylinders is not limited thereto and the engine 10 may be a tandem gasoline engine or a diesel engine. The K0 clutch 14, the motor 15, the torque converter 18, and the transmission 19 are provided in a transmission unit 11. The transmission unit 11 and the right and left driving wheels 13 are connected to each other via a differential 12 in a driving manner.

The K0 clutch 14 is provided between the engine 10 and the motor 15 on the power transmission path. When a hydraulic pressure is supplied in a disengaged state, the K0 clutch 14 is switched to an engaged state and sets up transmission of power between the engine 10 and the motor 15. When the supply of a hydraulic pressure is stopped, the K0 clutch 14 is switched to the disengaged state and cuts off transmission of power between the engine 10 and the motor 15. The engaged state is a state in which two engagement elements of the K0 clutch 14 are coupled and thus the engine 10 and the motor 15 have the same rotation speed. The disengaged state is a state in which the two engagement elements of the K0 clutch 14 are decoupled from each other.

The motor 15 is connected to a battery 16 via an inverter 17. The motor 15 serves as a motor that generates a driving force for the vehicle with supply of electric power from the battery 16 and also serves as a power generator that generates electric power for charging the battery 16 with transmission of power from the engine 10 or the driving wheels 13. Electric power transmitted or received between the motor 15 and the battery 16 is adjusted by the inverter 17.

The inverter 17 is controlled by an ECU 100 which will be described later and is configured to convert a DC voltage from the battery 16 to an AC voltage or to convert an AC voltage from the motor 15 to a DC voltage. In a powered operation in which the motor 15 outputs a torque, the inverter 17 converts a DC voltage from the battery 16 to an AC voltage and adjusts electric power supplied to the motor 15. In a regenerative operation in which the motor 15 generates electric power, the inverter 17 converts an AC voltage from the motor 15 to a DC voltage and adjusts electric power supplied to the battery 16.

The torque converter 18 is a fluid coupling having a torque amplification function. The transmission 19 is a stepped automatic transmission that switches a gear ratio between a plurality of steps by switching a gear shift stage, but is not limited thereto and may be a stepless automatic transmission. The transmission 19 is disposed between the motor 15 and the driving wheels 13 on the power transmission path. The motor 15 and the transmission 19 are connected via the torque converter 18. The torque converter 18 includes a lockup clutch 20 that is engaged to directly connect the motor 15 and the transmission 19 when a hydraulic pressure is supplied.

The transmission unit 11 further includes an oil pump 21 and a hydraulic pressure control mechanism 22. A hydraulic pressure generated by the oil pump 21 is supplied to the K0 clutch 14, the torque converter 18, the transmission 19, and the lockup clutch 20 via the hydraulic pressure control mechanism 22. Hydraulic circuits of the K0 clutch 14, the torque converter 18, the transmission 19, and the lockup clutch 20 and various hydraulic pressure control valves for controlling hydraulic pressures thereof are provided in the hydraulic pressure control mechanism 22. A wet clutch may be provided instead of the torque converter 18.

The hybrid electric vehicle 1 includes an electronic control unit (ECU) 100 as a control device. The ECU 100 is an electronic control unit including an arithmetic operation circuit that performs various arithmetic operations associated with traveling control of the hybrid electric vehicle and a memory in which control programs or data is stored. The ECU 100 is an example of the control device and functionally realizes a measuring unit, a count unit, and a correction unit of which details will be described later.

The ECU 100 controls operations of the engine 10 and the motor 15. Specifically, the ECU 100 controls a torque or a rotation speed of the engine 10 by controlling a throttle opening, an ignition timing, and an amount of injected fuel of the engine 10. The ECU 100 controls a rotation speed or a torque of the motor 15 by adjusting an amount of electric power transmitted and received between the motor 15 and the battery 16 through control of the inverter 17. The ECU 100 controls operations of the K0 clutch 14, the lockup clutch 20, and the transmission 19 through control of the hydraulic pressure control mechanism 22.

Signals from an ignition switch 71, a crank angle sensor 72, a motor rotation speed sensor 73, an accelerator operation amount sensor 74, an air flowmeter 75, a pressure sensor 76, and a coolant temperature sensor 77 are input to the ECU 100. The crank angle sensor 72 detects a rotation speed of a crank shaft of the engine 10. The motor rotation speed sensor 73 detects a rotation speed of an output shaft of the motor 15. The accelerator operation amount sensor 74 detects an amount of accelerator pedal operation which is an amount of depression of an accelerator pedal from a driver. The air flowmeter 75 detects an amount of intake air of the engine 10. The pressure sensor 76 detects a pressure in an intake air passage 35 downstream from a throttle valve 40 which will be described later. The coolant temperature sensor 77 detects a temperature of a coolant in the engine 10.

The ECU 100 causes the hybrid electric vehicle to travel in one traveling mode of a motor mode and a hybrid mode. In the motor mode, the ECU 100 disengages the K0 clutch 14 and causes the hybrid electric vehicle to travel with power from the motor 15. In the hybrid mode, the ECU 100 switches the K0 clutch 14 to the engaged state and causes the hybrid electric vehicle to travel with at least power from the engine 10. The hybrid mode includes a mode in which the hybrid electric vehicle travels with only power from the engine 10 and a mode in which the motor 15 is operated by powering and the hybrid electric vehicle travels using both the engine 10 and the motor 15 as power sources.

The traveling mode is switched based on a required driving force for the vehicle which is calculated based on a vehicle speed or an accelerator operation amount, a state of charge of the battery 16, and the like. For example, when the required driving force is relatively small and an SOC value indicating the state of charge of the battery 16 is relatively high, the motor mode in which the engine 10 is stopped is selected to improve fuel efficiency. When the required driving force is relatively large or the SOC value of the battery 16 is relatively low, the hybrid mode in which the engine 10 operates is selected.

The ECU 100 performs intermittent operation control of automatically stopping the engine 10 when a predetermined stopping condition is satisfied, and restarting the automatically stopped engine 10 when a predetermined restarting condition is satisfied. For example, when the accelerator operation amount is zero in the hybrid mode, the ECU 100 determines that an automatic stopping condition is satisfied and automatically stops the engine 10. For example, when the accelerator operation amount becomes greater than zero, the ECU 100 determines that a restarting condition is satisfied and automatically restarts the engine 10. At the time of automatic stopping, the ECU 100 disengages the K0 clutch 14 to stop combustion. At the time of automatic restarting, the ECU 100 cranks the engine 10 using the motor 15 via the K0 clutch 14 to start combustion and then engages the K0 clutch 14.

### Schematic Configuration of Engine

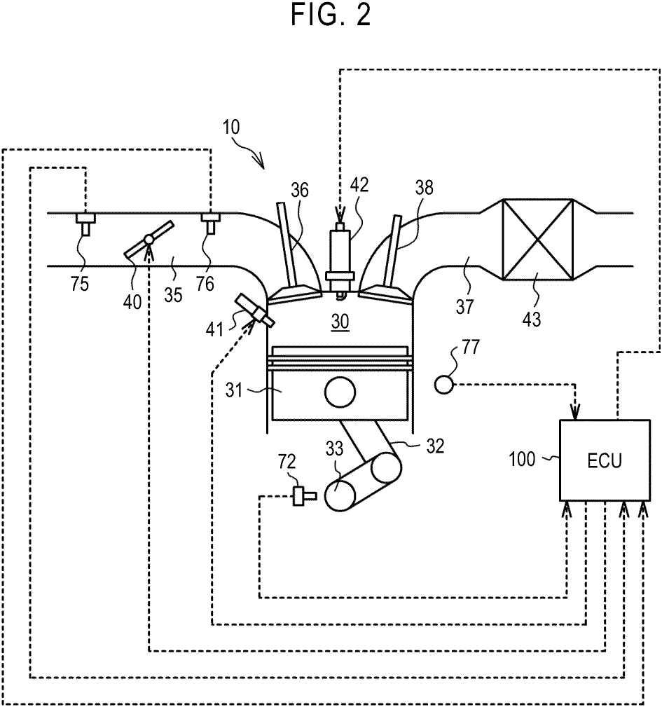

FIG. 2 is a diagram schematically illustrating a configuration of the engine 10. The engine 10 includes a cylinder 30, a piston 31, a connecting rod 32, a crank shaft 33, an intake air passage 35, an intake valve 36, an exhaust gas passage 37, and an exhaust valve 38. In FIG. 2, only one of a plurality of cylinders 30 in the engine 10 is illustrated. In the cylinder 30, combustion of an air-fuel mixture is performed. The piston 31 is accommodated in each cylinder 30 such that it can reciprocate, and is connected to the crank shaft 33 which is an output shaft of the engine 10 via the connecting rod 32. The connecting rod 32 converts a translational motion of the piston 31 to a rotational motion of the crank shaft 33.

The intake air passage 35 is connected to an intake port of each cylinder 30 via the intake valve 36. The exhaust gas passage 37 is connected to an exhaust port of each cylinder 30 via the exhaust valve 38. The air flowmeter 75, the pressure sensor 76, and a throttle valve 40 that adjusts an amount of intake air are provided in the intake air passage 35. A catalyst 43 for cleaning exhaust gas is provided in the exhaust gas passage 37.

A cylinder injection valve 41 is provided in the cylinder 30. The cylinder injection valve 41 injects fuel directly into the cylinder 30. A port injection valve that injects fuel to the intake port may be provided instead of the cylinder injection valve 41 or in addition to the cylinder injection valve 41. A spark plug 42 that ignites an air-fuel mixture of intake air introduced via the intake air passage 35 and fuel injected from the cylinder injection valve 41 using spark discharge is provided in each cylinder 30.

When a start request for the engine 10 is issued as described above, combustion in the engine 10 is started by supplying electric power to the spark plug 42 while cranking the engine 10 via the K0 clutch 14 using the motor 15. Here, a power supply time of the spark plug 42 is correlated with a predetermined crank angle section. For example, in a predetermined crank angle section including a compression top dead point (for example, 30°CA), the spark plug 42 is normally supplied with electric power. Accordingly, for example, when a cranking torque is insufficient and thus an engine rotation speed in cranking decreases, the power supply time of the spark plug 42 is extended. When this long-time power supply is repeated, there is concern about deterioration of durability of the spark plug 42. Accordingly, the ECU 100 according to this embodiment performs the following control.

### Control for Calculating Count Values LC and SC

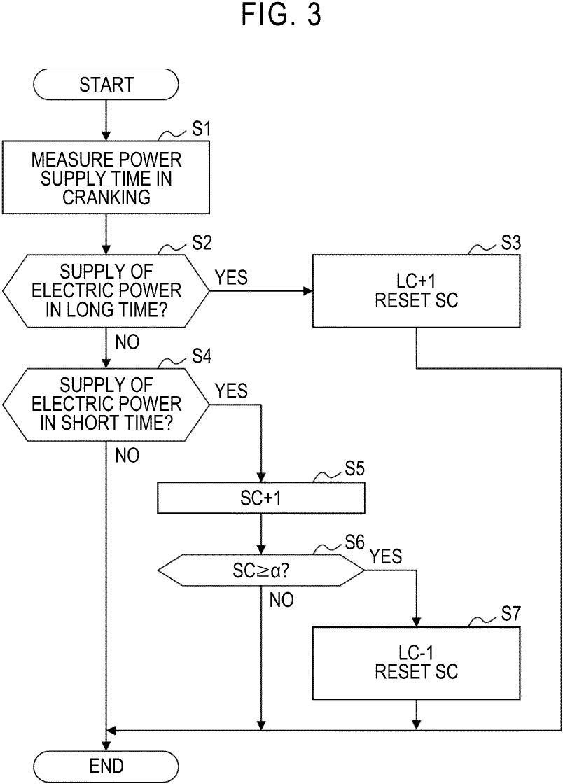

The ECU 100 performs control for calculating a count value LC indicating a long-time power supply number of the spark plug 42 and a count value SC indicating a short-time power supply number. FIG. 3 is a flowchart illustrating an example of the control for calculating the count values LC and SC. This control is performed when an ignition switch is turned on. In this control, the count values LC and SC are calculated for each spark plug 42 provided in the corresponding one of a plurality of cylinders 30. The ECU 100 measures the power supply time of the spark plug 42 in cranking of the engine 10 (Step S1). A period of cranking is a power supply time of the spark plug 42 in one combustion cycle after cranking of the engine 10 has been started via the K0 clutch 14 using the motor 15 and before combustion in the engine 10 has been started to engage the K0 clutch 14. Step S1 is an example of a process which is performed by the measuring unit.

Then, the ECU 100 determines whether it is long-time power supply in which the measured power supply time is equal to or longer than a first time (Step S2). The first time is a minimum time in which there is a likelihood that durability of the spark plug 42 will deteriorate by repeated supply of electric power. When the determination result of Step S2 is YES, the ECU 100 adds “1” to the count value LC and resets the count value SC to “0” (Step S3). Step S3 is an example of a process which is performed by the count unit.

When the determination result of Step S2 is NO, the ECU 100 determines whether it is short-time power supply in which the measured power supply time is shorter than a second time (Step S4). The second time is set to a time shorter than the first time. Although details will be described later, the second time is a maximum time in which there is no likelihood that a decrease in cranking torque which has been temporarily increased will affect durability of the spark plug 42. When the determination result of Step S4 is NO, this control ends.

When the determination result of Step S4 is YES, the ECU 100 adds “1” to the count value SC (Step S5). Then, the ECU 100 determines whether the count value SC is equal to or greater than a predetermined value α (Step S6). The predetermined value α is set to a value greater than 1. When the determination result of Step S6 is YES, the ECU 100 subtracts “1” from the count value LC and resets the count value SC to “0” (Step S7). When the determination result of Step S6 is NO, this control ends.

### Cranking Torque Correction Control

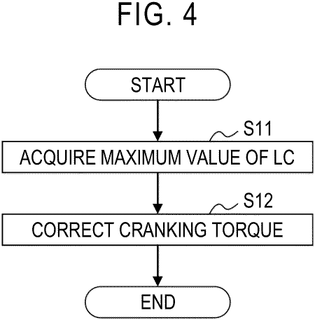

FIG. 4 is a flowchart illustrating an example of cranking torque correction control. This control is repeatedly performed when the ignition switch is turned on and the operation of the engine 10 is stopped, but the disclosure is not limited thereto and the control may be performed only when a start request for the engine 10 is issued. The ECU 100 acquires a maximum value out of the count values LC for the cylinders (Step S11). Then, the ECU 100 corrects the cranking torque based on the count value LC which is the maximum value (Step S12).

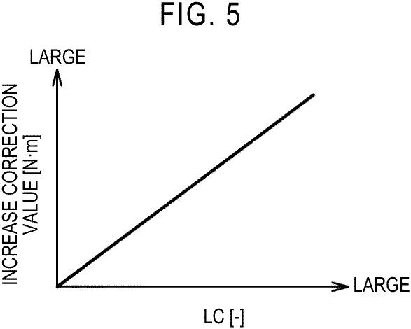

FIG. 5 is a map in which a relationship between the count value LC and an increase correction value of the cranking torque is defined. In FIG. 5, the horizontal axis represents the count value LC and the vertical axis represents an increase correction value. As illustrated in FIG. 5, the increase correction value increases as the count value LC increases. The ECU 100 calculates an increase correction value of the cranking torque with reference to the map illustrated in FIG. 5 and corrects the cranking torque by adding the increase correction value to a basic cranking torque which will be described later. When a start request for the engine 10 is issued, the ECU 100 causes the motor 15 to output the corrected cranking torque and cranks the engine 10 via the K0 clutch 14. Step S12 is an example of a process which is performed by the correction unit.

The basic cranking torque is a torque with which the engine 10 can be appropriately cranked and which has been acquired by experiment in advance and, for example, may be a variable value which varies depending on a stop position of the engine 10 or may be a predetermined fixed value. Accordingly, the basic cranking torque is set to a torque with which the engine 10 can be cranked without affecting durability of the spark plug 42. However, the basic cranking torque alone may be insufficient for a necessary and sufficient torque depending on an individual difference of the engine 10, an individual difference of the K0 clutch 14, aging deterioration of the engine 10, other environmental conditions, and the like. Accordingly, by adding the increase correction value to the basic cranking torque as described above, the cranking torque is corrected.

In the example illustrated in FIG. 5, the increase correction value increase linearly as the count value LC increases, but the disclosure is not limited thereto and the increase correction value may increase in a curved shape or increase in a stepped shape. The increase correction value may be calculated using a calculation expression using the count value LC as an argument. When correction is performed such that cranking torque increases as the count value LC increases, for example, the cranking torque may be corrected by increasing a correction coefficient equal to or greater than 1 as the count value LC increases and multiplying the basic cranking torque by the correction coefficient.

In this way, the cranking torque is corrected to increase as the count value LC increases. When the cranking torque increases, the engine rotation speed in cranking increases and thus extension of the power supply time of the spark plug 42 is curbed. Accordingly, it is possible to secure durability of the spark plug 42.

As described above, the cranking torque is corrected using the maximum value of the count values LC for the spark plugs 42 (Steps S11 and S12). Accordingly, the cranking torque can be increased based on the spark plug 42 of which durability is most likely to deteriorate. As a result, it is also possible to secure durability of the spark plug 42.

When the determination results of both Steps S2 and S4 are NO, the count value LC is not subjected to addition or subtraction and the cranking torque is maintained at a current value. In this case, the cranking torque is set to a torque with which long-time power supply of the spark plug 42 can be avoided and thus it is possible to curb an unnecessary increase of the cranking torque while securing durability of the spark plug 42. Here, in order to secure startability of the engine 10 which is traveling in the motor mode, it is necessary to cause the hybrid electric vehicle to travel using the motor 15 while normally securing a surplus torque corresponding to the cranking torque out of the torque which can be output from the motor 15. Accordingly, when the cranking torque is larger than necessary, a traveling area in the motor mode may be reduced and thus fuel efficiency may decrease. When the determination results of both Steps S2 and S4 are NO, the cranking torque is maintained at the current value and thus it is possible to secure the traveling area in the motor mode and to curb a decrease in fuel efficiency.

As described above, when the count value SC is equal to or greater than the predetermined value α, “1” is subtracted from the count value LC (Steps S6 and S7). Accordingly, it is possible to decrease the increase correction value and to decrease the cranking torque which has been temporarily increased by correction. For example, when the short-time power supply number is increased by performing maintenance of the vehicle in which the long time power supply number has been increased and the cranking torque has been increased, it is possible to decrease the cranking torque which has been temporarily increased. Accordingly, it is also possible to secure the traveling area in the motor mode and to curb a decrease in fuel efficiency.

The predetermined value α is a value greater than “1” which is the addition value of the count value LC when the long-time power supply has been determined. Accordingly, the magnitude of a rate of decrease of the cranking torque with an increase of the short-time power supply number is smaller than the magnitude of a rate of increase of the cranking torque with an increase of the long-time power supply number. Accordingly, it is possible to carefully decrease the cranking torque which has been temporarily increased and to secure durability of the spark plug 42.

As described above, the count value SC is reset whenever the long-time power supply number is counted (Steps S2 and S3). Accordingly, it is possible to carefully decrease the cranking torque and to preferentially secure durability of the spark plug 42.

In Steps S3, S5, and S7, the addition values or the subtraction values for the count values are the same, but the disclosure is not limited thereto and some or all thereof may be different.

When the determination result of Step S2 is YES, “1” is added to the count value LC and the count value SC is reset (Step S3), but the disclosure is not limited thereto. For example, when the determination result of Step S2 is YES, “1” is added to the count value LC, but the count value SC may be reset whenever the count value LC reaches a predetermined value greater than 1.

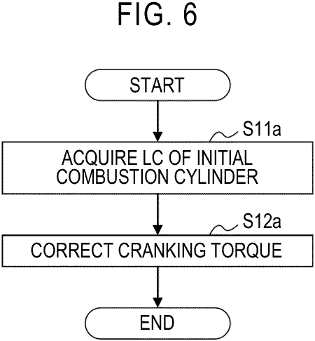

A modified example of the cranking torque correction control will be described below. FIG. 6 is a flowchart illustrating a modified example of the cranking torque correction control. The ECU 100 acquires the count value LC of a cylinder in which combustion is to start initially (hereinafter referred to as an initial combustion cylinder) (Step S11a). For example, when the initial combustion cylinder is a cylinder 30 in which the piston 31 is stopped in a compression stroke, the ECU 100 ascertains the cylinder 30 based on the crank angle at the stop position of the engine 10 and acquires the count value LC of the cylinder 30.

Then, the ECU 100 corrects the cranking torque based on the count value LC (Step S12a). In cranking the engine 10, the engine rotation speed when the spark plug 42 in the initial combustion cylinder is supplied with electric power is lower than the engine rotation speed when the spark plugs 42 in the other cylinders are supplied with electric power, and the power supply time of the spark plug 42 in the initial combustion cylinder is longer than those of the spark plug 42 in the other cylinders. By correcting the cranking torque depending on the count value LC in the initial combustion cylinder in which the power supply time is the longest, it is possible to secure durability of the spark plug 42.

In the aforementioned embodiment, the hybrid electric vehicle is controlled by a single ECU 100, but the disclosure is not limited thereto. For example, the aforementioned control may be performed by a plurality of ECUs such as an engine ECU that controls the engine 10, a motor ECU that controls the motor 15, a clutch ECU that controls the K0 clutch 14.

While an embodiment of the disclosure has been described above in detail, the disclosure is not limited to such a specific embodiment and various modifications and alterations can be performed thereon without departing from the gist of the disclosure described in the appended claims.

What is claimed is:

1. A hybrid electric vehicle comprising:
an engine that is a power source for traveling including a cylinder and a spark plug provided in the cylinder;
a motor that is a power source for traveling;
a clutch that is provided between the engine and the motor; and
a control device configured to start combustion in the engine by supplying electric power to the spark plug while cranking the engine via the clutch using the motor when a start request for the engine is issued,
wherein the control device includes:
a measuring unit configured to measure a power supply time of the spark plug in cranking of the engine;
a count unit configured to count a long-time power supply number which is the number of times the power supply time is equal to or greater than a predetermined first time; and
a correction unit configured to correct a cranking torque necessary for cranking the engine and required for the motor such that the cranking torque increases as the long-time power supply number increases.

2. The hybrid electric vehicle according to claim 1, wherein the count unit is configured to count a short-time power supply number which is the number of times the power supply time is equal to or less than a second time shorter than the first time and to decrease the long-time power supply number when the short-time power supply number is equal to or greater than a predetermined number.

3. The hybrid electric vehicle according to claim 2, wherein the count unit is configured to reset the short-time power supply number whenever the counted long-time power supply number reaches a predetermined number.

4. The hybrid electric vehicle according to claim 1, wherein the engine includes a plurality of the cylinders and a plurality of the spark plugs that is provided in the plurality of cylinders, respectively,
wherein the measuring unit is configured to measure the power supply time for each of the plurality of spark plugs,
wherein the count unit is configured to count the long-time power supply number for each of the plurality of spark plugs, and
wherein the correction unit is configured to correct the cranking torque based on a maximum value out of the long-time power supply numbers of the plurality of spark plugs.

5. The hybrid electric vehicle according to claim 1, wherein the engine includes a plurality of the cylinders and a plurality of the spark plugs that is provided in the plurality of cylinders, respectively,
wherein the measuring unit is configured to measure the power supply time for each of the plurality of spark plugs,
wherein the count unit is configured to count the long-time power supply number for each of the plurality of spark plugs, and
wherein the correction unit is configured to correct the cranking torque based on the long-time power supply number of the spark plug of the cylinder in which combustion is to start initially in cranking the engine.
